(19) United States
(12) Patent Application Publication
(10) Pub. No.: US 2015/0014934 A1
(43) Pub. Date: Jan. 15, 2015

(54) FOAMABLE SEALING MATERIAL, FOAMABLE SEALING MEMBER, SEALING FOAM, AND METHOD FOR SEALING SPACE

(71) Applicant: NITTO DENKO CORPORATION, Osaka (JP)

(72) Inventor: Takehiro Ui, Osaka (JP)

(73) Assignee: NITTO DENKO CORPORATION, Osaka (JP)

(21) Appl. No.: 14/384,222

(22) PCT Filed: Mar. 15, 2013
(86) PCT No.: PCT/JP2013/057523

§ 371 Date: Sep. 10, 2014

(30) Foreign Application Priority Data
Mar. 21, 2012 (JP) 2012-064238

(51) Int. Cl. F16J 15/02

(52) U.S. Cl. CPC F16J 15/022
USPC 277/316; 277/650

(57) ABSTRACT

A foamable sealing material contains a polymer, a foaming agent, and a fire retardant. The fire retardant contains 5 to 110 parts by mass of metal hydroxide and 5 to 110 parts by mass of a halogen organic compound relative to 100 parts by mass of the polymer. The foamable sealing material is foamable for sealing a space.

### TECHNICAL FIELD

The present invention relates to a foamable sealing material, a foamable sealing member, a sealing foam, and a method for sealing a space. To be specific, the present invention relates to a sealing foam that seals a space, a sealing method, a foamable sealing member for forming a sealing foam, and a foamable sealing material.

### BACKGROUND ART

Conventionally, it has been known that an inner space of a hollow member formed as a closed cross section, for example, an automotive pillar, is filled and sealed with a foam to prevent the vibration and noise of an engine and wind noise to be transmitted to a vehicle interior.

For example, Patent Document 1 below has proposed the following. A foam composition for filling containing an ethylene-vinyl acetate copolymer and 4,4′-oxybis(benzene sulfonyl hydrazide) is prepared. The foam composition for filling is disposed at an inner space of a hollow member, and thereafter, heated and foamed to produce a foam for filling. The inner space of the hollow member is filled with the foam for filling, and the inner space is sealed with the foam for filling.

The foam for filling described in Patent Document 1 below has a high expansion ratio, and therefore is excellent in sealing an inner space.

### PRIOR ART DOCUMENT

### Patent Document

### Patent Document 1:

Japanese Unexamined Patent Publication No. 2005-97586

### SUMMARY OF THE INVENTION

### Problems to be Solved by the Invention

Recently, there has been a demand for preventing more effectively the transmission of engine vibration and noise, and therefore an attempt has been made to seal an inner space with a foam by disposing a foam composition for filling also at an inner space of a hollow member disposed near the engine room.

In such a case, the hollow member is exposed to high temperature from the heat generated from the engine, and therefore the foam needs excellent flame retardancy that can effectively suppress burning from the exposure to high temperature.

However, there may be a case where the foam for filling described in Patent Document 1 above may not be satisfactory in providing excellent flame retardancy described above sufficiently.

An object of the present invention is to provide a sealing foam with excellent sealing properties and excellent flame retardancy, a foamable sealing member for forming the sealing foam, a foamable sealing material, and a method for sealing a space therewith.

### Means for Solving the Problems

A foamable sealing material of the present invention includes a polymer, a foaming agent, and a fire retardant, wherein the fire retardant contains 5 to 110 parts by mass of metal hydroxide and 5 to 110 parts by mass of a halogen organic compound relative to 100 parts by mass of the polymer, and the foamable sealing material is foamable for sealing a space.

In the foamable sealing material of the present invention, it is preferable that the metal hydroxide is aluminum hydroxide and/or magnesium hydroxide.

In the foamable sealing material of the present invention, it is preferable that the halogen organic compound is a bromine organic compound and/or a chlorine organic compound.

In the foamable sealing material of the present invention, it is preferable that the bromine organic compound is ethylenebis(pentabromophenyl) and/or decabromodiphenyloxide, and the chlorine organic compound is chlorinated polyethylene.

A foamable sealing member of the present invention includes the above-described foamable sealing material, and an attachment member to be attached to the foamable sealing material and is attachable to the inner space of the hollow member, wherein the foamable sealing material includes a polymer, a foaming agent, and a fire retardant, and the fire retardant contains 5 to 110 parts by mass of metal hydroxide and 5 to 110 parts by mass of a halogen organic compound relative to 100 parts by mass of the polymer, and the foamable sealing material is foamable for sealing the inner space.

A sealing foam of the present invention is a sealing foam produced by foaming the above-described foamable sealing material, wherein the foamable sealing material contains a polymer, a foaming agent, and a fire retardant; and the fire retardant contains 5 to 110 parts by mass of metal hydroxide and 5 to 110 parts by mass of a halogen organic compound relative to 100 parts by mass of the polymer.

A method for sealing a space of the present invention includes the steps of disposing the above-described foamable sealing material in a space, and foaming the foamable sealing material to produce a sealing foam, wherein the foamable sealing material includes a polymer, a foaming agent, and a fire retardant, and the fire retardant contains 5 to 110 parts by mass of metal hydroxide and 5 to 110 parts by mass of a halogen organic compound relative to 100 parts by mass of the polymer.

### Effect of the Invention

The foamable sealing material of the present invention included in the foamable sealing member of the present invention contains a polymer, a foaming agent, and a fire retardant; and the fire retardant contains metal hydroxide and a halogen organic compound at a specific mixing ratio.

Therefore, a sealing foam of the present invention produced by foaming the foamable sealing material of the present invention has a high expansion ratio, excellent sealing properties, and excellent flame retardancy.

Thus, in a method for sealing a space of the present invention, the foamable sealing material is disposed in a space, and thereafter, the foamable sealing material is foamed to produce a sealing foam; therefore, the sealing foam with excellent flame retardancy can seal a space reliably.

### BRIEF DESCRIPTION OF THE DRAWINGS

FIG. 1 is a process drawing of a method for sealing an inner space of a hollow member disposed in or near an engine room of an automobile with a foamable sealing material, a foamable sealing member, and a sealing foam of the present invention,

FIG. 1(a) illustrating a step of attaching an attachment member to the foamable sealing material to produce a foamable sealing member, and disposing the foamable sealing member in the hollow member, and

FIG. 1(b) illustrating a step of foaming the foamable sealing material by heating, thereby sealing the inner space of the hollow member with the sealing foam.

### EMBODIMENT OF THE INVENTION

A foamable sealing material of the present invention is foamable for sealing a space. To be specific, the foamable sealing material of the present invention contains a polymer, a foaming agent, and a fire retardant.

Examples of the polymer include a resin and/or rubber produced by polymerization of a monomer having at least one ethylene unsaturated double bond. These polymers can be used singly or in combination of two or more.

Examples of the resin include vinyl polymers (polymer of vinyl monomer) such as vinyl copolymers and olefin polymers. Examples of the resin also include polyvinyl butyral resin and polyvinyl chloride resin. For the resin, preferably, a vinyl polymer, more preferably, a vinyl copolymer and an olefin polymer are used.

Specific examples of the vinyl copolymer include a copolymer of a vinyl-group-containing ester and an olefin.

Examples of the vinyl-group-containing ester include fatty acid vinyl ester and (meth)acrylate.

Examples of the fatty acid vinyl ester include vinyl acetate, vinyl propionate, and vinyl butyrate.

The (meth)acrylate is an acrylate and/or methacrylate. Examples of the (meth)acrylate include methyl (meth)acrylate, ethyl (meth)acrylate, propyl (meth)acrylate, isopropyl (meth)acrylate, and butyl (meth)acrylate.

These vinyl-group-containing esters can be used singly or in combination.

For the vinyl-group-containing ester, the fatty acid vinyl ester is used preferably or, more preferably, the vinyl acetate is used.

Examples of the olefin include ethylene and propylene. These olefins can be used singly or in combination.

For the olefin, ethylene is used preferably.

Specific examples of the above vinyl copolymer include olefin-fatty acid vinyl ester copolymers such as an ethylene-vinyl acetate copolymer (EVA), an ethylene-vinyl propionate copolymer, an ethylene-vinyl butyrate copolymer, and an ethylene-propylene-vinyl acetate copolymer, and olefin-(meth)acrylate copolymers such as an ethylene-methyl (meth)acrylate copolymer, an ethylene-ethyl (meth)acrylate copolymer (EEA/EMA), an ethylene-propyl (meth)acrylate copolymer, and an ethylene-butyl (meth)acrylate copolymer.

The above vinyl copolymer is a block copolymer or random copolymer.

These vinyl copolymers can be used singly or in combination of two or more.

For the vinyl copolymer, the olefin-fatty acid vinyl ester copolymer is used preferably or, more preferably, the EVA is used.

The vinyl copolymer has a vinyl group-containing ester (to be specific, fatty acid vinyl ester, preferably, vinyl acetate) content of, for example, 5 to 60 mass %, preferably 10 to 45 mass %.

The olefin polymer is a hydrocarbon-based polymer which does not substantially have an oxygen-atom containing portion such as an ester bond in a molecular thereof. Specifically, the olefin polymer is a polymer of an olefin.

Examples of the olefin include those olefins given as examples of the monomers forming the vinyl copolymer.

Examples of the olefin polymer include polyethylene (ethylene homopolymer), polypropylene (propylene homopolymer), and an ethylene-propylene copolymer.

These olefin polymers can be used singly or in combination.

For the olefin polymer, polyethylene is used preferably.

Examples of the resin also include, other than the resin produced by polymerization of a monomer having at least one ethylene unsaturated double bond, resins composed of polycondensates including polyester resin and polyamide resin.

These resins can be used singly or can be used in combination.

Examples of the rubber include conjugated diene polymers. The conjugated diene polymer is a polymer of a monomer containing conjugated diene, and examples include styrene-butadiene rubber (SBR), polybutadiene rubber (BR), and ethylene-propylene-diene rubber (EPDM). Preferably, EPDM is used.

EPDM is a synthetic rubber obtained by copolymerization of ethylene, propylene, and diene. To be specific, EPDM is produced by copolymerization of an ethylene-propylene copolymer (EPM) with diene.

Examples of dienes include 5-ethylidene-5-norbornene, 1,4-hexadiene, and dicyclopentadiene. Preferably, 5-ethylidene-5-norbornene is used.

EPDM has a diene content of, for example, 1 to 20 mass %, preferably 3 to 10 mass %. EPDM has an ethylene content of, for example, 50 to 97 mass %, preferably 60 to 95 mass %.

These rubbers can be used singly, or can be used in combination.

The polymer has a melt flow rate (MFR) of, for example, 10.0 g/10 min or less, preferably 7.5 g/10 min or less, and for example, 1.0 g/10 min or more, preferably 1.5 g/10 min or more.

The MFR is obtained by the measurement method in conformity with JISK7210 (1999) and JISK6922-1 (1997). To be specific, the MFR of the vinyl copolymer is obtained by measurement in conformity with JISK7210 (1999) with a heating temperature of 190° C. and a load of 21.18N; and the MFR of the olefin polymer is obtained by measurement in conformity with JISK6922-1 (1997) with a heating temperature of 190° C. and a load of 21.18N.

The polymer has a Mooney viscosity of, for example, 50ML₁₊₄ (100° C.) or less, preferably 40ML₁₊₄ (100° C.) or less, and for example, 5ML₁₊₄ (100° C.) or more, preferably 10ML₁₊₄ (100° C.) or more. The Mooney viscosity is obtained by measurement in conformity with ASTM D 1646 at a heating temperature of 100° C.

The mixing ratio of the polymer relative to the foamable sealing material is, for example, 10 to 90 mass %, preferably 25 to 85 mass %.

Examples of the foaming agent include thermally decomposable foaming agents of inorganic foaming agents and organic foaming agent.

Examples of the inorganic foaming agent include ammonium carbonate, ammonium hydrogen carbonate, sodium hydrogen carbonate, ammonium nitrite, sodium borohydride, and azides.

Examples of the organic foaming agent include N-nitroso compounds (N,N′-dinitrosopentamethylenetetramine, N,N′-dimethyl-N,N′-dinitrosoterephthalamide, etc.), azocompounds (e.g., azobisisobutyronitrile, azodicarbonamide (ADCA), barium azodicarboxylate, etc.), fluorinated alkanes (e.g., trichloromonofluoromethane, dichloromonofluoromethane, etc.), hydrazine compounds (e.g., paratoluene sulfonyl hydrazide, diphenylsulfone-3,3′-disulfonylhydrazide, 4,4′-oxybis(benzene sulfonyl hydrazide)(OBSH), allylbis(sulfonylhydrazide), etc.), semicarbazide compounds (e.g., p-toluylenesulfonylsemicarbazide, 4,4′-oxybis(benzenesulfonylsemicarbazide), etc.), and triazole compounds (e.g., 5-morpholyl-1,2,3,4-thiatriazole, etc.).

Examples of the foaming agent also include gas-encapsulated microcapsule foaming agents, to be more specific, thermal expansion microparticles in which a thermally expandable substance (e.g., isobutane, pentane, etc.) is encapsulated in microcapsules (e.g., microcapsules composed of thermoplastic resins such as vinylidene chloride, acrylonitrile, acrylate, and methacrylate). Examples of such thermally expandable microparticles include commercially available products such as Microsphere (trade name, manufactured by Matsumoto Yushi-Seiyaku Co., Ltd.).

These foaming agents can be used singly or in combination of two or more.

Of these foaming agents, preferably, azo compounds and hydrazine compounds are used, and more preferably, ADCA and OBSH are used.

The mixing ratio of the foaming agent relative to 100 parts by weight of the polymer is, for example, 5 to 30 parts by mass, preferably 10 to 25 parts by mass. When the mixing ratio of the foaming agent is below the above-described range, the expansion ratio of a sealing foam obtained from the foamable sealing material becomes low, and a large foamable sealing material has to be formed to seal a space, which may reduce workability in attachment. When the mixing ratio of the foaming agent is more than the above-described range, an expansion ratio suitable for the mixing ratio may not be achieved, which may be disadvantageous in costs.

The fire retardant contains metal hydroxide and a halogen organic compound.

Metal hydroxide is solid, and examples thereof include metal hydroxide of metal elements such as aluminum (Al), magnesium (Mg), calcium (Ca), nickel (Ni), cobalt (Co), tin (Sn), zinc (Zn), copper (Cu), and iron (Fe).

Examples of metal hydroxide include aluminum hydroxide, magnesium hydroxide, calcium hydroxide, nickel hydroxide, cobalt hydroxide, tin hydroxide, zinc hydroxide, copper hydroxide, and iron hydroxide.

The metal hydroxide can be used singly, or can be used in combination.

For the metal hydroxide, preferably, in view of flame retardancy, aluminum hydroxide and magnesium hydroxide are used.

Commercially available products can be used for the metal hydroxide, including HIGILITE series (aluminum hydroxide, manufactured by Showa Denko K.K.) and KISUMA series (magnesium hydroxide, manufactured by Kyowa Chemical Industry Co., Ltd.).

The shape of the metal hydroxide can be, for example, spherical, acicular, and platy.

The average value of the maximum length of the metal hydroxide is (when spherical, the average particle size), for example, 1 nm to 100 μm, preferably 5 nm to 50 μm, more preferably 10 nm to 1 μm.

When the metal hydroxide is, for example, aluminum hydroxide or magnesium hydroxide, and the metal hydroxide generates water from thermal decomposition as shown in formula (1) or (2) below.

Mg(OH)₂→MgO+H₂O (1)

2Al(OH)₃→Al₂O₃+3H₂O (2)

These thermal decompositions are endothermic reaction. Particularly, with aluminum hydroxide or magnesium hydroxide, the above-described endothermic reaction progresses at a wide temperature range of 200 to 400° C.

Thus, with the above-described generation of water and endothermic reaction, the afterglow time (the time that glowing of the sample persists after a sample molded from the foamable sealing material and the sealing foam is combusted and the flame of the sample died down) of the foamable sealing material and sealing foam can be shortened, and excellent flame retardancy can be given to the foamable sealing material and the sealing foam.

The mixing ratio of the metal hydroxide relative to 100 parts by mass of the polymer is, 5 to 110 parts by mass, preferably 5 to 80 parts by mass, more preferably 10 to 60 parts by mass, even more preferably 20 to 40 parts by mass.

When the mixing ratio of the metal hydroxide is more than the above-described range, the expansion ratio may be reduced. Meanwhile, when the mixing ratio of the metal hydroxide is below the above-described range, flame retardancy may be reduced.

The halogen organic compound is solid, and examples thereof include those organic compounds having halogen atoms such as fluorine atoms, chlorine atoms, bromine atoms, and iodine atoms in their molecules, including a fluorine organic compound having a fluorine atom in its molecule, a chlorine organic compound having a chlorine atom in its molecule, a bromine organic compound having a bromine atom in its molecule, an iodine organic compound having an iodine atom in its molecule, and an organic compound having a plurality of types of halogen atoms in its molecule. Preferably, a chlorine organic compound, and a bromine organic compound are used.

Examples of the chlorine organic compound include chlorinated polyolefin of chlorinated polyethylene produced by chlorination of polyethylenes, and chlorine rubber such as chloroprene rubber. Preferably, chlorinated polyolefin is used, more preferably, chlorinated polyethylene is used.

Examples of the bromine organic compound include bromine aromatic compounds such as tetrabromo bisphenol A, ethylenebis(pentabromophenyl), ethylenebistetrabromophthalimide, tetrabromophthalic anhydride, and brominated polystyrene; bromine alicyclic compounds such astetrabromocyclooctane, dibromomethyl-dibromocyclohexane, hexabromocyclododecane; and bromine ether compounds such as decabromodiphenyloxide (decabromodiphenylether), tetradecabromodiphenoxybenzene, and TBA-bisdibromopropylether.

For the bromine organic compound, preferably, bromine aromatic compounds, and bromine ether compounds are used, and more preferably, in view of flame retardancy, stability, and handleability, ethylenebis(pentabromophenyl) and decabromodiphenyloxide are used.

Commercially available products can be used for the halogen organic compound, and for example, ELASLEN series (chlorine organic compound, manufactured by Showa Denko K.K.), and SAYTEX series (bromine organic compound, manufactured by ALBEMARLE JAPAN CORPORATION) are used.

The halogen organic compound has a halogen content of, for example, 5 to 95 mass %, preferably 10 to 90 mass %. When the halogen organic compound is a chlorine organic compound, the chlorine content relative to the chlorine organic compound is, for example, 10 to 60 mass %, preferably 20 to 50 mass %, and when the halogen organic compound is a bromine organic compound, the bromine content relative to the bromine organic compound is, for example, 45 to 99 mass %, preferably 55 to 95 mass %.

The halogen organic compound generates hydrogen halide (to be specific, hydrogen fluoride, hydrogen chloride, hydrogen bromide, and hydrogen iodide) gas when decomposed by heating and in this manner, oxygen supply to the foamable sealing material and the sealing foam can be shut effectively. In this manner, the combustion time of the foamable sealing material and the sealing foam can be shortened, and excellent flame retardancy can be given to the foamable sealing material and the sealing foam.

The shape of the halogen organic compound can be, for example, spherical, acicular, and platy, and the average value of its maximum length (when spherical, the average particle size) is, for example, 1 nm to 100 μm, preferably 100 nm to 20 μm.

The halogen organic compound has a melting point of, for example, 200 to 400° C., preferably 250 to 375° C. The melting point of the halogen organic compound can be set to, for example, 100 to 200° C., preferably 125 to 175° C.

The mixing ratio of the halogen organic compound relative to 100 parts by mass of the polymer is, 5 to 110 parts by mass, preferably 5 to 80 parts by mass, more preferably 10 to 60 parts by mass, even more preferably 20 to 50 parts by mass.

When the mixing ratio of the halogen organic compound is more than the above-described range, the expansion ratio may be reduced. Meanwhile, when the mixing ratio of the halogen organic compound is below the above-described range, flame retardancy may be reduced.

The ratio of metal hydroxide relative to the halogen organic compound on mass basis (metal hydroxide/halogen organic compound) is, for example, 1/10 to 10/1, preferably 1/3 to 3/1. When the above-described ratio is within the above-described range, corrosion and environment burden can be reduced while giving excellent flame retardancy to the foamable sealing material and the sealing foam.

When the above-described ratio is more than the above-described range, flame retardancy may be reduced, and when the above-described ratio is below the above-described range, corrosion based on the halogen organic compound may be generated.

The mixing ratio of the fire retardant, that is, a total amount of the metal hydroxide and halogen organic compound relative to 100 parts by mass of the polymer is, for example, 10 to 220 parts by mass, preferably 10 to 160 parts by mass, more preferably 20 to 120 parts by mass, even more preferably 40 to 100 parts by mass.

The fire retardant contains the above-described metal hydroxide and halogen organic compound, and therefore while excellent flame retardancy is given to the foamable sealing material and sealing foam, a foamable sealing material and a sealing foam with less corrosion and environment burden can be provided.

Known additives can be added in a suitable proportion to the foamable sealing material, including, for example, foaming accelerators, cross-linking agents, crosslinking accelerators, antirust agents, and furthermore, fillers, lubricants, plasticizers, age resisters, antioxidants, pigments, coloring agents, mildew resistant agents, fire retardants (fire retardant other than the metal hydroxide and halogen organic compound), and softeners.

Examples of the foaming auxiliary agent include urea compounds, higher fatty acids such as salicylic acid and stearic acid or metal salts thereof (e.g., zinc salt), and metal oxides such as zinc oxide.

The foaming accelerator can be used singly, or can be used in combination.

For the foaming accelerator, preferably, zinc higher fatty acid, and metal oxide are used.

The mixing ratio of the foaming accelerator relative to 100 parts by mass of the foaming agent is, for example, 1 to 100 parts by mass, preferably 5 to 50 parts by mass. The mixing ratio of the foaming accelerator relative to 100 parts by mass of the polymer is, for example, 1 to 20 parts by mass, preferably 2 to 10 parts by mass.

Examples of the cross-linking agent include organic peroxide.

Organic peroxides are radical generators that are capable of being decomposed by heating, generating free radicals, and allowing crosslinking of polymer; and examples thereof include dicumyl peroxide (DCP), 1,1-ditertiarybutylperoxy-3,3,5-trimethylcyclohexane, 2,5-dimethyl-2,5-ditertiarybutylperoxyhexane, 2,5-dimethyl-2,5-ditertiarybutylperoxyhexane, 1,3-bis(tertiarybutylperoxyisopropyl)benzene, tertiarybutylperoxyketone, and tertiarybutylperoxybenzoate.

The cross-linking agent can be used singly, or can be used in combination of two or more.

For the cross-linking agent, preferably, DCP is used.

The mixing ratio of the cross-linking agent relative to 100 parts by mass of the polymer is, for example, 0.1 to 10 parts by mass, preferably 0.2 to 5 parts by mass. When the mixing ratio of the cross-linking agent is less than the range shown above, a viscosity increase resulting from cross-linking is small and foam cells may be broken due to the pressure of a gas during foaming. When the mixing ratio of the cross-linking agent is more than the above-described range, excessive crosslinking occurs and the coating of the polymer suppresses the gas pressure at the time of foaming, and foaming with a high expansion ratio may not be performed.

Examples of the crosslinking accelerator include (meth)acryloyl group-containing compounds containing a plurality of (meth)acryloyl groups such as ethylene glycol di(meth)acrylate, trimethylolpropane tri(meth)acrylate (TMPTA/TMPTMA), pentaerythritoltri (meth)acrylate, pentaerythritol tetra(meth)acrylate, and dipentaerythritolhexa (meth)acrylate; allyl group-containing compounds such astriallylisocyanurate (TAIL) and triallylcyanurate (TAC); hydroxyimino group-containing compounds (oximes) such as p-quinone dioxime; imino and amino groups-containing compounds such as guanidine; imide group-containing compounds such as N,N′-m-phenylenebismaleimide; carboxyl group-containing compounds such as zinc acrylate (e.g., unsaturated fatty acid metal salt); vinyl group-containing compounds such as 1,2-polybutadiene; and sulfur compounds such as sulfur.

These crosslinking accelerators can be used singly or in combination of two or more.

For the crosslinking accelerator, preferably, (meth)acryloyl group-containing compounds, more preferably, (meth)acryloyl group-containing compounds having three or more (meth)acryloyl groups such as TMPTA, TMPTMA, pentaerythritoltri (meth)acrylate, pentaerythritoltetra (meth)acrylate, and dipentaerythritolhexa (meth)acrylate are used.

When the (meth)acryloyl group-containing compound having three or more (meth)acryloyl groups are used, strong crosslinking can be achieved with the (meth)acryloyl group, and a high expansion ratio can be ensured.

The mixing ratio of the crosslinking accelerator relative to 100 parts by mass of the cross-linking agent is, for example, 1 to 20 parts by mass, preferably 2 to 15 parts by mass. The mixing ratio of the cross-linking auxiliary agent is in a range of, for example, 0.05 to 1.5 parts by mass, or preferably 0.1 to 1.0 parts by mass relative to 100 parts by mass of the polymer.

The antirust agent is not particularly limited, and for example, basic oxides described in Japanese Unexamined Patent Publication No. 2005-97586 can be used. To be specific, calcium oxide, magnesium oxide, ferrous oxide, and ferric oxide can be used.

The antirust agent can be used singly, or can be used in combination.

For the antirust agent, preferably, magnesium oxide is used.

The antirust agent has an average particle size of, for example, 1 nm to 100 nm.

The mixing ratio of the antirust agent relative to 100 parts by mass of the foaming agent is, for example, 0.05 to 50 parts by mass, preferably 0.1 to 10 parts by mass.

To prepare the foamable sealing material of the present invention, the above-described components are blended at the above-described mixing ratio, and homogeneously mixed.

To be specific, the foamable sealing material can be prepared by kneading the above-described components with, for example, a mixing roll, a pressure kneader, and an extruder.

Kneading conditions include a heating temperature in a range of, for example, 50 to 130° C., or preferably 95 to 120° C., and a heating time in a range of, for example, 0.5 to 30 minutes, or preferably 1 to 20 minutes.

Furthermore, in the preparation, the obtained kneaded material is molded into a predetermined form, thereby preparing a preform.

Molding of the kneaded product is performed by, for example, molding the kneaded product directly into a predetermined shape (e.g., a sheet-like shape) by calender-molding or press-molding. Alternatively, for example, the kneaded material can be pelletized with, for example, a pelletizer, and can be molded into a predetermined shape with an injection molding apparatus or an extruder.

The molding conditions include a molding temperature of, for example, 60 to 120° C., preferably 75 to 115° C.

Then, the thus obtained foamable sealing material of the present invention is heated under suitable conditions and is foamed, thereby forming a sealing foam of the present invention.

The volume expansion ratio (density before foaming/density after foaming) of the thus obtained sealing foam of the present invention is, for example, 4 times or more, preferably 6 times or more, more preferably 10 times or more, even more preferably 14 times or more, and for example, 40 times or less.

The volume expansion ratio of the sealing foam is suitably set in accordance with the types of the foaming agent, and when the foaming agent is an azo compound (to be specific, ADCA), for example, the volume expansion ratio is set to 6 times or more, preferably 10 times or more. When the foaming agent is a hydrazine compound (to be specific, OBSH), for example, the volume expansion ratio is set to, for example, 4 times or more, preferably, 6 times or more, more preferably, 10 times or more, even more preferably, 14 times or more.

With such a volume expansion ratio, sealing properties of the sealing foam relative to space can be improved.

Preferably, in “FMVSSNo. 302” flammability test in conformity with (ISO6795, JIS D1201), the sealing foam does not burn to the point of benchmark line B (that is, self extinguished (flame is died out)), that is, the specified burning rate cannot be measured, preferably self extinguished at the point of 200 mm or less from the distal end, more preferably self extinguished at the point of 100 mm or less from the distal end, even more preferably self extinguished at the point of 50 mm or less from the distal end, particularly preferably self extinguished at the point of 30 mm or less from the distal end.

The thus obtained sealing foam of the present invention is capable of adding various effects such as reinforcement, vibration damping, sound insulation, dust prevention, heat insulation, cushioning, and watertight effects to various members that defines a space, and therefore can be suitably used for a foamable filler that fills a space of various members for various industrial products, including, for example, reinforcement materials, vibration damping materials, sound insulating materials, dustproof materials, heat insulating materials, cushioning materials, and water stopping materials.

Examples of the members that define a space to be sealed with the sealing foam of the present invention include, for example, two members that are disposed to face each other in spaced-apart relation, for example, a hollow member in which an inner space is formed.

To seal a space with the sealing foam of the present invention, for example, the foamable sealing material is set between the above-described members or in the inner space of a hollow member, and thereafter, the foamable sealing material set is heated to foam, thereby forming a sealing foam and charging the sealing foam between the members or in the inner space of the hollow member. In this manner, the gap between the members or the inner space of a hollow member is sealed with the sealing foam.

To be more specific, to fill the inner space of a hollow member with the sealing foam, for example, first, an attachment member attachable to the hollow member is attached to the foamable sealing material, thereby preparing a foamable sealing member including the foamable sealing material and attachment member. Then, the attachment member is attached to the hollow member so that the foamable sealing material is disposed in the inner space, and thereafter, the foamable sealing material is foamed by heating, thereby forming a sealing foam. In this manner, the inner space of the hollow member is filled with the sealing foam, thereby sealing the inner space.

Examples of the hollow member include a hollow member provided in an engine room or near the engine room in automobiles.

Then, by preparing the foamable sealing member with the foamable sealing material of the present invention, and attaching the attachment member to the hollow member, and foaming, the inner space of the hollow member is sealed with the sealing foam, thereby achieving sufficient reinforcement of the hollow member, while effectively suppressing transmission of vibration and noise of an engine to a vehicle interior.

When a space between two members is filled with the sealing foam, for example, first, the foamable sealing member is made. Then, the attachment member is attached, for example, to one of the members so that the foamable sealing material is disposed between the two members, and thereafter, the foamable sealing material is foamed by heating, thereby forming a sealing foam. In this manner, the space between the two members is filled with the sealing foam to seal the space.

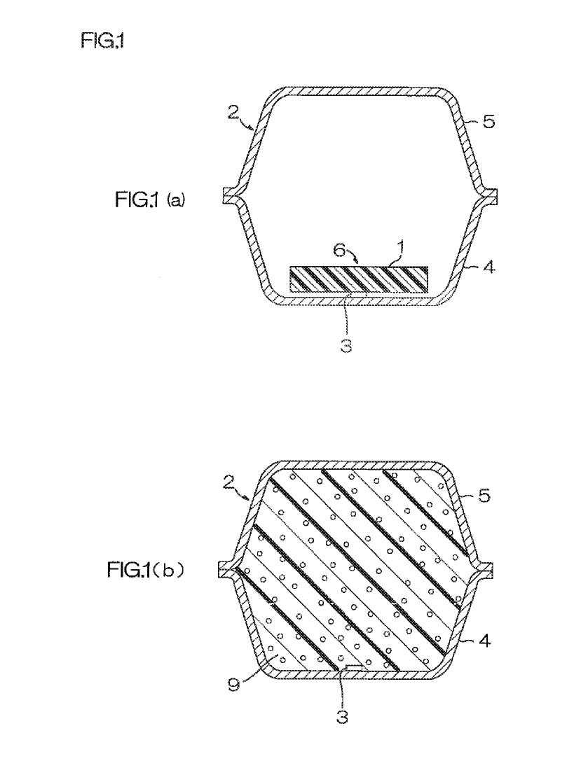

FIG. 1 is a process drawing of a method for sealing an inner space of a hollow member disposed in an engine room or near the engine room of an automobile with a foamable sealing material, a foamable sealing member, and a sealing foam of the present invention, FIG. 1(a) illustrating a step of attaching an attachment member to a foamable sealing material to prepare a foamable sealing member, and setting the foamable sealing member to a hollow member, and FIG. 1(b) illustrating a step of foaming the foamable sealing material to seal the inner space of the hollow member with the sealing foam.

Next, description is given below of a method for sealing an inner space of a hollow member disposed in or near an engine room of an automobile using a foamable sealing material, a foamable sealing member, and a sealing foam in an embodiment of the present invention with reference to FIG. 1.

In this method, first, as shown in FIG. 1 (a), a foamable sealing sheet 1 molded into a predetermined shape is placed in a hollow member 2.

The foamable sealing sheet 1 is formed from a foamable sealing material into a sheet. The thickness of the foamable sealing sheet 1 is suitably set in accordance with the expansion ratio and/or the inner space of the hollow member 2, for example, to 0.01 to 10 mm, preferably 0.05 to 5 mm.

The hollow member 2 includes an inner panel 4 and an outer panel 5 having a generally U-shape in cross section. The inner panel 4 is formed so that its center portion projects from the peripheral end portion thereof to one side in the thickness direction of the hollow member 2 (lower side in FIG. 1).

The outer panel 5 is formed so that its center portion projects from the peripheral end portion thereof to the other side in the thickness direction of the hollow member 2 (upper side in FIG. 1).

To place the foamable sealing sheet 1 in the hollow member 2, for example, first, an attachment member 3 is attached to the foamable sealing sheet 1 to produce a foamable sealing member 6 including the attachment member 3 and the foamable sealing sheet 1. Alternatively, at the time of molding the foamable sealing sheet 1, the attachment member 3 can be insert molded along with the kneaded material. Then, the attachment member 3 of the foamable sealing member 6 is attached to the inner panel 4.

After attaching the foamable sealing sheet 1 to the inner panel 4 with the attachment member 3, the peripheral end portions of the inner panel 4 and the outer panel 5 are allowed to face and bring into contact with each other, and joined. In this manner, the hollow member 2 is formed to have a closed cross section.

Thereafter, in this method, using the heat in the drying line process at the time of bake painting that follows, the hollow member 2 is heated at, for example, 140° C. or more and 180° C. or less, preferably 160° C. or more and 180° C. or less. In this manner, by foaming the foamable sealing sheet 1 as shown in FIG. 1 (b), the sealing foam 9 is formed.

With the sealing foam 9, the inner space of the hollow member 2 can be filled and sealed with almost no gap.

The shape, placement, disposing direction, and the number to be disposed of the foamable sealing sheet 1 can be suitably selected in accordance with, for example, the shape of the hollow member 2.

The foamable sealing sheet 1 included in the above-described foamable sealing member 6 contains a polymer, a foaming agent, and a fire retardant, and the fire retardant contains metal hydroxide and a halogen organic compound at a specific mixing ratio.

Thus, the sealing foam 9 obtained by foaming the foamable sealing sheet 1 has a high expansion ratio, excellent sealing properties, and excellent flame retardancy.

Therefore, in the above-described method for sealing the inner space of the hollow member 2, the foamable sealing sheet 1 is disposed in the inner space, and thereafter, the foamable sealing sheet 1 is foamed to produce the sealing foam 9, and therefore with the sealing foam 9 having excellent flame retardancy, the inner space of the hollow member 2 can be sealed reliably.

### EXAMPLES

While in the following, the present invention will be described more specifically by showing Examples and Comparative Examples, the present invention is not limited thereto.

### Examples 1 to 12 and Comparative Examples 1 to 6

The components in accordance with the mixing formulation shown in Table 1 to Table 3 are kneaded with a 6-inch mixing roll at a number of revolution of 15 min⁻¹, and at about 110° C. for 10 minutes, thereby preparing a kneaded material (foamable sealing material, foamable filler). Thereafter, the prepared kneaded material was hot pressed at 110° C., thereby molding a foamable sealing sheet having a thickness of 2.5 mm

(Evaluation)

The foamable sealing sheets produced in Examples and Comparative Examples were evaluated for the following items. The results are shown in Table 1 to Table 3.

### (1) Expansion Ratio

The foamable sealing sheet was punched into a circular disk having a diameter of 19 mm to prepare samples, and the produced samples were heated at 180° C. for 20 minutes, thereby foaming the samples. That is, sealing foams were produced. Then, based on the density of the sealing foam before foaming and the density of the sealing foam after foaming, the expansion ratio was calculated.

### (2) Flame Retardancy

Flame retardancy of the sealing foam produced in “(1) Expansion Ratio” was evaluated in conformity with “FMVSS No. 302” flammability test (ISO6795, JIS D1201).

That is, the sealing foam was cut into a size of 100 mm×356 mm to prepare samples, and the burning rate of the longitudinal direction of the sample was measured.

To be specific, first, at a portion 38.1 mm from one end in the longitudinal direction(distal end) of the sample, benchmark line A was drawn along the width direction, and benchmark line B was drawn along the width direction of the sample at a portion 254 mm from benchmark line A in the other side in the longitudinal direction. Thereafter, one end in the longitudinal direction of the sample was exposed to flame, and flame progression was observed: from the distal end passing benchmark line A towards benchmark line B. The burning rate of the sample between benchmark line A and benchmark line B was measured.

TABLE 1

| Examples•Comp. Ex. | | | | Example 1 | Example 2 | Example 3 | Example 4 | Example 5 | Example 6 | Example 7 |
|---|---|---|---|---|---|---|---|---|---|---|
| Blending | Polymer | Vinyl | EVA | 100 | 100 | 100 | 100 | 100 | 100 | 100 |
| formulation | | copolymer | | | | | | | | |
| of foamable | Cross-linking agent | | DCP | 5 | 5 | 5 | 5 | 5 | 5 | 5 |
| sealing | Foaming agent | | OBSH | 20 | 20 | 20 | 20 | 20 | 20 | 20 |
| material | Antirust agent | | Magnesium | 1.3 | 1.3 | 1.3 | 1.3 | 1.3 | 1.3 | 1.3 |
| (parts | | | oxide | | | | | | | |
| by mass) | Fire | Metal | Aluminium | 20 | 5 | 30 | 20 | 10 | — | 20 |
| | retardant | hydroxide | hydroxide | | | | | | | |
| | | | Magnesium | — | — | — | — | — | 10 | — |
| | | | hydroxide | | | | | | | |
| | | Halogen | Ethylenebis | 10 | 10 | 10 | 5 | 20 | 20 | — |
| | | organic | (pentabromo- | | | | | | | |
| | | compound | phenyl) | | | | | | | |
| | | | Decabromo- | — | — | — | — | — | — | 10 |
| | | | diphenyloxide | | | | | | | |
| | | | Chlorinated | — | — | — | — | — | — | — |
| | | | polyethylene | | | | | | | |

| | | | | | | | | |
|---|---|---|---|---|---|---|---|---|
| Evaluation of | Expansion Ratio (times) | 16.1 | 16.7 | 13.2 | 14.6 | 14.4 | 13.2 | 13.5 |
| Sealing foam | Flame retardancy | Self-extin- | Self-extin- | Self-extin- | Self-extin- | Self-extin- | Self-extin- | Self-extin- |
| | | guished | guished | guished | guished | guished | guished | guished |
| | | at 26 mm | at 30 mm | at 25 mm | at 32 mm | at 38 mm | at 29 mm | at 25 mm |
| | | from distal | from distal | from distal | from distal | from distal | from distal | from distal |
| | | end*¹ | end*¹ | end*¹ | end*¹ | end*¹ | end*¹ | end*¹ |

| Examples•Comp. Ex. | | | | Example 8 | Comp. Ex. 1 | Comp. Ex. 2 | Comp. Ex. 3 | Comp. Ex. 4 |
|---|---|---|---|---|---|---|---|---|
| Blending | Polymer | Vinyl | EVA | 100 | 100 | 100 | 100 | 100 |
| formulation | | copolymer | | | | | | |
| of foamable | Cross-linking agent | | DCP | 5 | 5 | 5 | 5 | 5 |
| sealing | Foaming agent | | OBSH | 20 | 10 | 10 | 10 | 10 |
| material | Antirust agent | | Magnesium | 1.3 | 1.3 | 1.3 | 1.3 | 1.3 |
| (parts | | | oxide | | | | | |
| by mass) | Fire | Metal | Aluminium | 20 | 5 | 20 | 2 | 120 |
| | retardant | hydroxide | hydroxide | | | | | |
| | | | Magnesium | — | — | — | — | — |
| | | | hydroxide | | | | | |
| | | Halogen | Ethylenebis | — | — | 2 | 20 | 120 |
| | | organic | (pentabromo- | | | | | |
| | | compound | phenyl) | | | | | |
| | | | Decabromo- | — | — | — | — | — |
| | | | diphenyloxide | | | | | |
| | | | Chlorinated | 10 | — | — | — | — |
| | | | polyethylene | | | | | |

| | | | | | | |
|---|---|---|---|---|---|---|
| Evaluation of | Expansion Ratio (times) | 7.3 | 18.0 | 17.0 | 16.5 | 2.6 |
| Sealing foam | Flame retardancy | Self-extin- | Burning rate | Burning rate | Burning rate | Self-extin- |
| | | guished | 70 mm/min | 59 mm/min | 62 mm/min | guished |
| | | at 35 mm | | | | at 2 mm |
| | | from distal | | | | from distal |
| | | end*¹ | | | | end |

*¹Burning rate not measurable

TABLE 2

| Example •Comp. Ex. | | | | Example 9 | Example 10 | Comp. Ex. 5 | Comp. Ex. 6 |
|---|---|---|---|---|---|---|---|
| Blending | Polymer | Vinyl | EVA | 100 | 100 | 100 | 100 |
| formulation | | copolymer | | | | | |
| of foamable | Cross-linking agent | | DCP | 5 | 5 | 5 | 5 |
| sealing | Crosslinking | | TMPTA | 0.3 | 0.3 | 0.3 | 0.3 |
| material | accelerator | | | | | | |
| (parts | Foaming agent | | ADCA | 10 | 10 | 10 | 10 |
| by mass) | Foaming accelerator | | Zinc oxide | 5 | 5 | 5 | 5 |
| | | | Zinc stearate | 5 | 5 | 5 | 5 |
| | Fire | Metal | Aluminium hydroxide | 50 | 100 | — | 120 |
| | retardant | hydroxide | Magnesium hydroxide | — | — | — | — |
| | | Halogen | Ethylenebis(pentabromo- | 50 | 100 | — | 120 |
| | | organic | phenyl) | | | | |
| | | compound | | | | | |

| | | | | | |
|---|---|---|---|---|---|
| Evaluation of | Expansion Ratio (times) | 12.2 | 9.0 | 16.5 | 2.5 |
| Sealing foam | Flame retardancy | Self-extin- | Self-extin- | Burning rate | Self-extin- |
| | | guished | guished | 120 mm/min | guished |
| | | at 14 mm | at 11 mm | | at 5 mm |
| | | from distal | from distal | | from distal |
| | | end *¹ | end | | end |

*¹ Burning rate not measurable

TABLE 3

| Example | | | | Example 11 | Example 12 |
|---|---|---|---|---|---|
| Blending | Polymer | Olefin polymer | PE | 100 | — |
| formulation | | | EPT | — | 100 |
| of foamable | Cross-linking agent | | DCP | 5 | 5 |
| sealing material | Foaming agent | | OBSH | 20 | 20 |
| (parts by mass) | Antirust agent | | Magnesium oxide | 1.3 | 1.3 |
| | Fire | Metal hydroxide | Aluminium hydroxide | 30 | 20 |
| | retardant | Halogen organic | ethylenebis | 30 | 10 |
| | | compound | (pentabromophenyl) | | |
| Evaluation of Sealing | | Expansion Ratio (times) | | 13.4 | 5.6 |
| foam | | Flame retardancy | | Self- | Self- |
| | | | | extinguished | extinguished |
| | | | | at 27 mm | at 22 mm |
| | | | | from | from |
| | | | | distal end *¹ | distal end |

*¹Burning rate not measurable

The values in Table 1 to Table 3 show parts by mass of the components unless otherwise specified.

The abbreviations of the components in Table 1 to Table 3 are described below. EVA: trade name “EVAFLEX EV460”, ethylene-vinyl acetate copolymer, MFR 2.5 g/10 min (in conformity with JIS K7210 (1999), heating temperature 190° C., load 21.18N), vinyl acetate content 19 wt %, manufactured by Du Pont-Mitsui Polychemicals Co., Ltd.

DCP: trade name “PERCUMYL D-40MBK”, dicumyl peroxide, DCP content 40 mass %, silica+EPDM content 60 mass %, manufactured by NOF corporation
OBSH: trade name “Cellmic SX”, 4,4′-oxybis(benzene sulfonyl hydrazide)(OBSH), manufactured by SANKYO KASEI Co., Ltd.
Magnesium oxide: trade name “Kyowamag 150”, average particle size 18 nm, manufactured by Kyowa Chemical Industry Co., Ltd.
Aluminum hydroxide: trade name “HIGILITE H32”, average particle size 18 nm, manufactured by Showa Denko K.K.
Magnesium hydroxide: trade name “KISUMA 5A”, average particle size 0.8 nm, manufactured by Kyowa Chemical Industry Co., Ltd.
Ethylenebis(pentabromophenyl): trade name “SAYTEX 8010”, melting point: 350° C., bromine content 82 mass %, average particle size 5 nm, manufactured by ALBEMARLE JAPAN CORPORATION
Decabromodiphenyloxide: trade name “SAYTEX 102E”, melting point: 304° C., bromine content 83 mass %, average particle size 6 nm, manufactured by ALBEMARLE JAPAN CORPORATION
Chlorinated polyethylene: ELASLEN 401A, melting point: 140° C., chlorine content 40 mass %, manufactured by Showa Denko K.K.
TMPTA: trade name “TMP 3A”, trimethylol propane triacrylate manufactured by Osaka Organic Chemical Industry Ltd.
ADCA: trade name “Vinyhole AC#3C”, azodicarbonamide manufactured by Eiwa Chemical Industrial Co., Ltd.
Zinc Oxide: trade name “Zinc Oxide #2”, manufactured by Mitsui Mining & Smelting Co., Ltd.
Zinc stearate: trade name “SZ-P”, manufactured by SAKAI CHEMICAL INDUSTRY CO., LTD.
PE: Sumikathene G201, polyethylene, melt flow rate: 2 g/10 min (in conformity with JIS K6922-1 (1997), heating temperature 190° C., load 21.18N)
EPT: trade name “Mitsui EPT X-3012P”, EPDM, Mooney viscosity: 15ML₁₊₄ (100° C.) in conformity with (ASTM D 1646), heating temperature 100° C., ethylene content 71.8 mass %, diene content 3.6 mass %

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

A sealing foam obtained by foaming a foamable sealing material can be used as a foamable filler that fills a space of a member for various industrial products, including, for example, reinforcement materials, vibration damping materials, sound insulating materials, dustproof materials, heat insulating materials, cushioning materials, and water stopping materials.

1. A foamable sealing material comprising a polymer, a foaming agent, and a fire retardant, wherein
the fire retardant comprises 5 to 110 parts by mass of metal hydroxide and 5 to 110 parts by mass of a halogen organic compound relative to 100 parts by mass of the polymer, and
the foamable sealing material is foamable for sealing a space.

2. The foamable sealing material according to claim 1, wherein the metal hydroxide is aluminum hydroxide and/or magnesium hydroxide.

3. The foamable sealing material according to claim 1, wherein the halogen organic compound is a bromine organic compound and/or a chlorine organic compound.

4. The foamable sealing material according to claim 3, wherein the bromine organic compound is ethylenebis(pentabromophenyl) and/or decabromodiphenyloxide, and
the chlorine organic compound is chlorinated polyethylene.

5. A foamable sealing member comprising:
a foamable sealing material,
an attachment member to be attached to the foamable sealing material and is attachable to the inner space of the hollow member,
wherein the foamable sealing material comprises a polymer, a foaming agent, and a fire retardant,
the fire retardant comprises 5 to 110 parts by mass of metal hydroxide and 5 to 110 parts by mass of a halogen organic compound relative to 100 parts by mass of the polymer, and
the foamable sealing material is foamable for sealing the inner space.

6. A sealing foam obtained by foaming a foamable sealing material, wherein
the foamable sealing material comprises a polymer, a foaming agent, and a fire retardant,
the fire retardant comprises 5 to 110 parts by mass of metal hydroxide and 5 to 110 parts by mass of a halogen organic compound relative to 100 parts by mass of the polymer.

7. A method for sealing a space comprising the steps of:
disposing a foamable sealing material in a space, and
foaming the foamable sealing material to produce a sealing foam,
wherein the foamable sealing material comprises a polymer, a foaming agent, and a fire retardant, and
the fire retardant contains 5 to 110 parts by mass of metal hydroxide and 5 to 110 parts by mass of a halogen organic compound relative to 100 parts by mass of the polymer.
